(19) United States
(12) Patent Application Publication
(10) Pub. No.: US 2002/0072582 A1
(43) Pub. Date: Jun. 13, 2002

(54) New coating binders with urea and/or hydantoin structures, a process for their production and their use

(76) Inventors: Rolf Gertzmann, Leverkusen (DE); Lutz Schmalstieg, Koln (DE); Jan Mazanek, Koln (DE); Bernd Hausstatter, Leverkusen (DE)

Correspondence Address: BAYER CORPORATION, PATENT DEPARTMENT, 100 BAYER ROAD, PITTSBURGH, PA, 15205, US

(21) Appl. No.: 09/977,845

(22) Filed: Oct. 15, 2001

(30) Foreign Application Priority Data
Oct. 17, 2000 (DE) 10051394.8

(51) Int. Cl. C08G 18/80

(52) U.S. Cl. 528/45

(57) ABSTRACT

The invention relates to a binder comprising at least one blocked polyisocyanate having urea and/or hydantoin groups and at least one hydroxyl component having an ester, imide, amide and/or urethane group, at least one organic solvent and optionally other auxiliary substances and additives, a process for their production. The binders according to the invention form coatings with a high temperature resistance and a good solderability.

### BACKGROUND OF THE INVENTION

The invention relates to new coating binders with urea and/or hydantoin structures and a process for their production. The binders according to the invention form coatings with a high temperature resistance and a good solderability.

The electrical and electronics industry requires large quantities of coated wires to produce motors, transformers, cathode-ray tubes and other products. Since the design of modern machines is increasingly demanding smaller motors, coils, transformers, etc., and these operate at higher temperatures than their larger equivalent, increased demands are made of the temperature resistance (in the present application temperature resistance is defined by the softening temperature of the coating) of the wire coatings. A further requirement of the products in many applications is a rapid solderability of the products in order for an electrically conductive connection to be produced quickly and easily between the ends of the coated wires and other components.

The electrical insulating surface coating materials conventionally used today include the conventional high temperature resistant coatings in which polyhydantoins (e.g. FR-A 1 484 694, DE-A 246020), polyimides, polyamidimides (e.g. DE-A 3 544 548, DE-A 3 714 033, DE-A 3 817 614), or polyester amidimides (e.g. U.S. Pat. Nos. 3,652,471, 4,997,891, DE-A 3 249 497) form the main binder component. Wires coated with these products cannot be soldered below a temperature of 400 to 450° C., however.

By contrast, polyurethane-based electrical insulating coatings permit rapid solderability at comparatively low temperatures. The binders in the wire enamels used to this end are based on combinations of polyester polyols and phenol or alkanol-blocked polyisocyanates (DE-A 1 170 096 or DE-A 2 626 175). An improvement in solderability can be achieved by combining blocked polyisocyanates with hydroxy-functional oligourethanes (DE-A-1 644 794).

In S. Darling, “International Wire Standards—Progress Towards Harmonization” in Proceedings 19^{th} EEI Conference, Chicago, Sep. 25 to 28 1989, p. 56, polyesterimides with a temperature index of 180° C. are described as solderable, although solderability is still only achievable at temperatures above 400° C.

Polyesterimides with a high hydroxyl group content in combination with heat-resistant blocked polyisocyanates are solderable at 370° C. but display sharply declining properties in terms of tan δ breakpoint and softening temperature in comparison to the conventional polyesterimides. Amidimide-polyurethane combinations as described in EP 365 877 display similar disadvantages. EP A 752 434 describes increasing the softening temperature of solderable wires by the introduction of amide/imide group-containing blocked polyisocyanates. In comparison to U.S. Pat. No. 4,997,891 a clearly improved solderability is achieved in this way, although the softening temperature is not improved.

Polyisocyanates containing carbodiimide and/or uretonimine groups and their use for wire enamelling are known from EP-A 231 509. Depending on the reaction partner, these polyisocyanates are suitable for producing solderable (Example 1 of EP-A 231 509) or heat-resistant enamelled wires (Example 3 of EP-A 231 509).

According to EP-A 287 947, heat-resistant electrical insulating coatings are obtained by using unsaturated carboxylic acids in combination with polyisocyanates containing carbodiimide and/or uretonimine groups. If an isocyanurate-containing compound is used to produce the wire enamel displaying hydantoin structures (EP-A 287 947 Example 3), a wire enamel that is solderable at 420° C. is obtained with a softening temperature of 250° C.; if the mixture contains no other OH components besides the OH-containing blocking agent, non-solderable products with softening temperatures >300° C. are obtained (EP-A 287 947 Example 2).

The use of N,N′,N″-tris(2-hydroxyethyl) isocyanurate as an additive for polyurethane-based wire enamels (DE-A 3 133 571) also leads to heat-resistant enamelled wires.

U.S. Pat. No. 5,254,659 describes the production of heat-resistant, solderable wire enamels from polyimides and imide-modified polyurethanes. The low solids contents of the binders and the fact that the solvent is not commonly used in the wire enamel industry and is moreover comparatively expensive means that such products are certainly used only in exceptional cases and for coating thin wires.

In summary it can be established that the teaching of the known prior art amounts only to the production of electrical insulating coatings with high heat resistance (>300° C.), which are not solderable at 390° C. or can be soldered only slowly, or to the production of examples that can be soldered rapidly at 390° C. but display a heat resistance of ≦270° C.

It was therefore an object of the invention to provide a coating compound for heat-resistant substrates, particularly for wire enamelling of wires, combining both advantages of heat resistance >270° C. and improved solderability at a temperature of 390° C.

This object could be achieved by means of the electrical insulating coating binders described in greater detail below. The invention is based on the surprising experimental finding that by using blocked polyisocyanates displaying particular urea and/or hydantoin groups, electrical insulating coatings can be produced which despite their excellent heat resistance can be soldered at temperatures <400° C.

### SUMMARY OF THE INVENTION

The invention relates to a binder containing:

A) at least one blocked polyisocyanate having urea and/or hydantoin groups, prepared from

a) 40 to 60 wt. % of an organic polyisocyanate or a blend of organic polyisocyanates,

b) 5 to 25 wt. % of at least one aspartic acid ester,

c) optionally 0.1 to 10 wt. % of a polyhydroxy compound with a molecular weight between 62 and 3000 g/mol, and

d) 25 to 45 wt. % of a blocking agent for NCO groups, whereby the ratio of unreacted isocyanate groups to blocking agents is 1:0.8 to 1:2

B) at least one hydroxyl component having an ester, imide, amide and/or urethane group, and

C) at least one organic solvent,

D) optionally auxiliary substances and/or additives.

### DETAILED DESCRIPTION OF THE INVENTION

Blocked polyisocyanates with hydantoin or urea structure A) are known from EP-A 744 424, EP-A 744 425 and EP-A 744 426. According to the teaching of the cited publications, these compounds are characterized by an improved thermal stability and are particularly suitable for electrodeposition painting of motor vehicles.

U.S. Pat. No. 3,549,599 describes the production of polyhydantoins from aspartic acid esters together with the high temperature resistance of the products thus obtained. The person skilled in the art can derive neither an indication regarding the production of solderable, high temperature resistant wire enamel binders nor the use of these substances to produce solderable wire enamel binders from the teaching of this application, even in conjunction with other publications.

Aromatic, aliphatic or cycloaliphatic polyisocyanates, preferably polyisocyanates having a uniform or mean molecular weight of 140 to 500 with a statistical mean NCO functionality of a maximum of 2.6 are suitable as starting polyisocyanates a) for production of the blocked polyisocyanate A).

The polyisocyanate a) or the mixture of polyisocyanates a) used to prepare the blocked polyisocyanate component A) preferably contains aromatically bonded isocyanate groups having a statistical mean NCO functionality of 2 to 2.2 and an optionally statistical mean molecular weight of 174-300.

Such polyisocyanates include 1,4-phenylene diisocyanate, 2,4- and 2,6-diisocyanatotoluene (TDI) as well as any mixtures of these isomers, 4,4′-, 2,4′- and 2,2′-diisocyanatodiphenyl-methane (MDI) or any mixtures of these isomers or mixtures of these isomers with their higher homologues, such as are obtained by known methods including phosgenation of aniline/formaldehyde condensates, 1,5-naphthylene diisocyanate, 1,4-butane diisocyanate, 2-methylpentane-1,5-diisocyanate, 1,5-hexane diisocyanate, 1,6-hexane diisocyanate (HDI), 1,3- and 1,4-cyclohexane diisocyanate and any mixtures of these isomers, 2,4- and 2,6-diisocyanato-1-methylcyclohexane and any mixtures of these isomers, 3,5,5-trimethyl-3-isocyanato-methylcyclohexane isocyanate (IPDI) and dicyclohexylmethane-2,4′- and -4,4′-diisocyanate and any mixtures of these diisocyanates.

Preferred starting polyisocyanates a) are those with aromatically bonded isocyanate groups having a statistical mean NCO functionality of 2 to 2.2 and an optionally statistical mean molecular weight of 174 to 300. More preferred diisocyanates for use in this context are 2,4-diisocyanatotoluene and 2,6-diisocyanatotoluene, together with technical blends consisting of these isomers, together with 4,4′-, 2,4′- and 2,2′-diisocyanatodiphenylmethane or mixtures of these isomers or mixtures of these isomers with their higher homologues, such as are obtained by known methods including phosgenation of aniline/formaldehyde condensates, or any mixtures of the above aromatic polyisocyanates.

Suitable components b) for production of the blocked polyisocyanate coating resins A) are aspartic acid esters having the general structural formula (b)

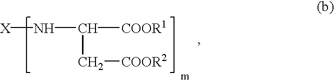

in which

X represents a m-valent organic radical optionally containing one or more heteroatoms, such as can be obtained by removing the primary amino group or groups from a corresponding monoamine or polyamine in the molecular weight range 60 to 6000 having (cyclo)aliphatically or araliphatically bonded primary amino groups, and which can contain further functional groups that are reactive to isocyanate groups and/or inert at temperatures up to 100° C.,

R¹ and R² mutually independently represent an aliphatic radical with 1 to 10 C atoms, an aromatic radical with 6 to 20 C atoms, an araliphatic radical with 7 to 20 C atoms, whereby R¹ and R² can also represent identical radicals and

m is 1, 2, 3 or 4,

which are obtained according to the teaching of EP-A 403 921, DE-A 1 670 812 and DE-A 2 158 945 by reacting a primary amine group-containing component i)

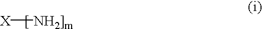

with fumaric acid esters and/or maleic acid esters having the formula (ii).

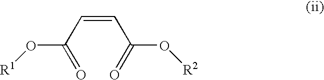

The radicals R¹ and R² preferably represent organic radicals with 1 to 9 carbon atoms, more preferably R¹ and R² are radicals with 1 to 4 carbon atoms.

Suitable amines (i) include difunctional amines (m=2) or mixtures of difunctional and higher-functional amines (m=2 and m=3 and/or m=4), such that the average functionality of the aspartic acid esters is ≧2. Mixtures of difunctional (m=2) and trifunctional (m=3) amines, whereby the equivalence ratio of di- to trifunctional amines is 1:2 to 5:1, are preferably suitable. Mixtures having an equivalence ratio of di- to trifunctional amines of 1:1.5 to 3:1 are more preferred.

Examples of suitable difunctional amines (i) include ethylene diamine, 1,2-diaminopropane, 1,4-diaminobutane, 2,5-diamino-2,5-dimethylhexane, 1,5-diamino-2-methylpentane (Dytek A), 1,6-diaminohexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane (IPDA), 2,4- and/or 2,6-hexahydrotoluylene diamine (H₆TDA), isopropyl-2,4- and/or 2,6-diaminocyclohexane, 1,3-bis(aminomethyl) cyclohexane, 2,4′- and/or 4,4′-diaminodicyclohexylmethane, 3,3′-dimethyl-4,4′-diamino-dicyclohexylmethane (Laromin C 260), isomers, diamino-dicyclohexylmethanes displaying a methyl group as ring substituent (═C-monomethyl-diaminodicyclohexylmethanes), 3(4)-aminomethyl-1-methylcyclohexylamine (AMCA) and 1,3-bis(aminomethyl) benzene.

Examples of trifunctional and higher-functional amines include 4-aminomethyl-1,8-octane diamine; 2,2′2″-triaminotriethylamine, 1,3,5-tris(aminomethyl)-2,4,6-triethyl benzene, tris-1,1,1-aminoethyl ethane, 1,2,3-triaminopropane, tris(3-aminopropyl)amine and N,N,N′,N′-tetrakis(2-aminoethyl) ethylene diamine.

Low-molecular polyether polyamines with aliphatically bonded primary amino groups, such as are sold by Huntsman under the name Jeffamin, for example, can also be used.

The aspartic acid esters b) can be produced both in solution and solvent-free. In both cases a preferably equimolar reaction of the amine with the fumaric or maleic acid diester occurs. The equivalence ratio of maleic or fumaric acid ester to amine i) is 1.2:1 to 1:2. Where mixtures of aspartic acid esters are used as component b), the aspartic acid esters can be produced separately or in one reaction vessel.

Low-molecular polyhydroxy compounds c) in quantities of approx. 0.1 to 5 wt. % can optionally be used in the preparation of the blocked polyisocyanate A). Suitable examples of low-molecular polyhydroxy compounds c) include diols and/or triols in the molecular weight range 62 to 350, as well as polyhydroxy compounds with molecular weights between 350 and 3000. Suitable polyhydroxy compounds c) in the molecular weight range 62 to 350 include ethylene glycol, propane diols, butane diols, hexane diols, di-, tri- or tetraethylene glycol, di-, tri- or tetrapropylene glycol, neopentyl glycol, 2-ethyl-1,3-hexane diol, 2,2,4-trimethyl-1,3-pentane diol, 1,4-bis(hydroxymethyl) cyclohexane, 2,2-bis(4-hydroxycyclohexyl) propane, glycerol, hexane triol, N,N′,N″-tris(2-hydroxyethyl) isocyanurate (THEIC) and pentaerythritol. Higher-molecular polyhydroxy compounds c) include the known polyhydroxy polyesters, such as are obtained from dicarboxylic acids such as phthalic acid, isophthalic acid, terephthalic acid or adipic acid with excess polyols of the above type. Known polyhydroxy polyethers that can be obtained by alkoxylation of low-molecular starter molecules, can likewise be used as polyols c).

The monofunctional compounds conventionally used for blocking isocyanate groups, in the molecular weight range 60 to 300, preferably 87 to 160, are suitable as blocking agents d). Examples are mentioned in Progress in Organic Coatings 3 73 et seq. (1975) and 9 3 et seq. (1981). Phenols, aliphatic alcohols, oximes, lactams, pyrazoles are preferred. Example as blocking agents d) include phenol, cresol, xylenol and technical isomer blends thereof, isopropanol, cyclohexanol, 1-methoxy-2-propanol, diethylene glycol monoethyl ether, benzyl alcohol, butanone oxime, cyclohexanone oxime, ε-caprolactam, dimethyl pyrazoles and optionally also mixtures of blocking agents. Phenol, cresols or xylenols are more preferred.

According to a preferred embodiment for production of the blocked polyisocyanate component (A), the starting diisocyanate a) is blocked with the blocking agent d) in the specified ratio. Depending on the type of blocking agent, blocking is performed in the temperature range from 20 to 200° C., preferably 60 to 160° C., until the calculated NCO content is reached or almost reached. Once blocking has been completed, a solvent or solvent blend C) is added, which can also be identical to or contain the blocking agent d).

In a second reaction stage the partially blocked diisocyanate is reacted with the mixture of difunctional and higher-functional aspartic acid esters b) and optionally a hydroxy compound c), in the temperature range from 60 to 200° C., preferably 80 to 130° C., until the free NCO content is <1%. The alcohol eliminated during hydantoin formation can either be removed from the reaction mixture by distillation under reduced pressure or remain in the reaction mixture.

If dissolved products are produced, the solvent or solvent blend C) can be added as described in the preferred embodiment, e.g. after blocking; in further embodiments, however, the blocking performed as the first reaction step can also be performed in the presence of a suitable solvent. A further embodiment for production of the blocked isocyanates A) is for example a one-pot reaction, in which polyisocyanate a), blocking agent d), aspartic acid ester b), optionally hydroxy compound c) and solvent C) are heated together. Catalysts known in polyurethane chemistry and described by way of example in the Kunststoffhandbuch, vol. 7, Polyurethane, p. 92 et seq., Carl Hanser Verlag, Munich Vienna 1983, can be used to accelerate the blocking reaction. If used, the catalysts are added in a quantity of 0.01 to 5.0% relative to the blocked polyisocyanates (I).

The invention also relates to a process for the production of binders for wire enamels by mixing the blocked polyisocyanate coating resins A) with hydroxyl components B) known in wire enamel coating technology, organic solvents C) and optionally auxiliary substances and additives D) at room temperature, wherein the hydroxyl component B) is used in an equivalence ratio of blocked isocyanate groups of component A) to hydroxyl groups of component B) of 1:1.5 to 2:1, preferably 1:1.3 to 1.5:1.

Suitable resins for component B) include resins with ester and/or amide and/or imide and/or urethane structures having hydroxyl end groups and known per se from wire enamel technology. An OH-terminated polyamidimide and/or polyimide with an amide and/or imide structure content of 0.5-10 wt. % (calculated as —CO—N<, MG=42) can preferably be used as hydroxyl component B). Polyfunctional OH-terminated polyurethanes with a urethane group content of 2-20 wt. % and particularly with a urethane group content of 4-15 wt. % can more preferably be used as component B).

Suitable organic solvents C) conventionally used in coating technology that are inert in respect of isocyanate groups include ethyl acetate, butyl acetate, ethylene glycol monomethyl or monoethyl acetate, 1-methoxypropyl-2-acetate, 2-butanone, 4-methyl-2-pentanone, cyclohexanone, toluene, xylene, solvent naphtha or mixtures. Plasticizers such as e.g. those based on phosphoric acid, sulfonic acid or phthalic acid esters can also be used but are less preferred. In addition to the coating solvents that are inert in respect of NCO groups, reactive solvents that are proportionally reactive to NCO groups can also be used. Monofunctional, aliphatic, cycloaliphatic, araliphatic alcohols or phenols such as e.g. isopropanol, n-butanol, n-octanol, 2-methoxy ethanol, 2-ethoxy ethanol, diethylene glycol monomethyl ether, diethylene glycol monoethyl ether, 1-methoxy-2-propanol are preferably suitable; cycloalkanols such as benzyl alcohol or phenols such as cresol, xylenol and technical isomer mixtures thereof.

Given that the monohydric alcohols or phenols mentioned here as solvents can also be used as blocking agents d), it already follows that if such alcohols or phenols are used as solvents they are not included in the calculation of the ratios of reaction partners a) to d).

Catalysts, pigments and/or flow control agents known from electrical insulating coating technology can be used according to the invention as auxiliary substances and additives D).

The electrical insulating coating binders according to the invention can be stored in the range from room temperature to relatively elevated temperatures (approx. 20-50° C.) and react only when heated to temperatures above 60° C., preferably 100 to 500° C. and particularly 180 to 400° C. under simultaneous evaporation of any volatile components that may be present to form crosslinked polymers.

The coatings are applied by immersion, roller, spray or absorbent pad methods known, whereby the coating films are then dried, i.e. cured, in a conventional drying oven in a temperature range from 100 to 500° C. and particularly from 180 to 400° C.

The invention also relates to the use of the binders according to the invention for coating substrates made from wood, plastic, metals, semimetals or mineral materials, as well as glass, glass fibres and bunched glass fibres and the resulting coated substrates.

The properties of the binders according to the invention make them outstandingly suitable for use as electrical insulating coating binders. In particular they have good solderability, high softening temperature and high heat shock temperature and good dielectric strength. Given the excellent electrical and mechanical properties of the binders according to the invention, the binders according to the invention are also suitable for the production of insulating fabrics or for impregnating electrical motors.

### EXAMPLES

### Example 1

Production of an Aspartic Acid Ester b)

173 g 4-aminomethyl-1,8-octane diamine and 116 g 2-methyl-1,5-pentane diamine were portioned out and 860 g maleic acid diethyl ester added with stirring such that a temperature of 50° C. was not exceeded in the reaction mixture. Stirring was then continued for 20 h at 60° C.

### Example 2

Production of a Blocked Polyisocyanate Coating Resin A)

A mixture consisting of 178.3 g aspartic acid ester from Example 1, 320 g m-cresol and 0.09 g DABCO (1,4-diaza{bicyclo[2,2,2]octane}) was dissolved in 230 g MPA and added dropwise over 2 h at 80° C. to 500 g of a technical isocyanate mixture from the diphenyl methane series with an NCO content of 32.5% (Desmodur VL 50, commercial product from Bayer AG). The reaction temperature was left at a maximum of 120° C., taking its exothermic character into consideration, until the free NCO content was less than 0.5%. The calculated, blocked NCO content was 10.2%.

### Example 3

Production of a Blocked Polyisocyanate Coating Resin A)

A mixture consisting of 184.1 g aspartic acid ester from Example 1, 360 g m-cresol and 0.09 g DABCO was dissolved in 250 g MPA and added dropwise over 2 h at 80° C. to 500 g 4,4′-diphenylmethane diisocyanate. The reaction temperature was left at a maximum of 120° C., taking its exothermic character into consideration, until the free NCO content was less than 0.5%. The calculated, blocked NCO content was 10.4%.

### Example 4

Production of a Blocked Polyisocyanate Coating Resin A)

A mixture consisting of 140.8 g aspartic acid ester (produced from 17.3 g 4-aminomethyl-1,8-octane diamine, 23.2 g 2-methyl-1,5-pentane diamine and 100.3 g maleic acid dimethyl ester by the method in Example 1, 360 g m-cresol and 0.09 g diazabicyclooctane was dissolved in 250 g methoxypropyl acetate and added dropwise over 2 h at 80° C. to 500 g Desmodur 44 M (commercial product from Bayer AG). The reaction temperature was left at a maximum of 120° C., taking its exothermic character into consideration, until the free NCO content was less than 0.5%. The calculated, blocked NCO content was 11.1%.

### Example 5

Production of a Blocked Polyisocyanate Coating Resin A)

A mixture consisting of 105.0 g aspartic acid ester (produced from 17.3 g 4-aminomethyl-1,8-octane diamine, 12.8 g 2-methyl-1,5-pentane diamine and 75.0 g maleic acid dimethyl ester by the method in Example 1, 8.0 g 1,4-butane diol, 360 g m-cresol and 0.09 g diazabicyclooctane was dissolved in 250 g MPA and added dropwise over 2 h at 80° C. to 500 g Desmodur 44 M. The reaction temperature was left at a maximum of 120° C., taking its exothermic character into consideration, until the free NCO content was less than 0.5%. The calculated, blocked NCO content was 11.3%.

### Example 6

Production of a Blocked Polyisocyanate Coating Resin A)

The reaction product of 17.4 g 4-aminomethyl-1,8-octane diamine, 23.2 g 2-methyl-1,5-pentane diamine and 118.3 g maleic acid diethyl ester, produced by the method in Example 1, was dissolved together with 360 g cresol and 0.09 g diazabicyclooctane in 250 g MPA and added dropwise over 2 h at 80° C. to 500 g Desmodur 44 M. The reaction temperature was left at a maximum of 120° C., taking its exothermic character into consideration, until the free NCO content was less than 0.5%. The calculated, blocked NCO content was 10.9%.

### Example 7

Production of a Polyisocyanate Coating Resin A)

The reaction product of 11.7 g 4-aminomethyl-1,8-octane diamine, 28.8 g 2-methyl-1,5-pentane diamine and 120.0 g maleic acid diethyl ester, produced by the method in Example 1, was dissolved together with 360 g cresol and 0.09 g DABCO in 250 g MPA and added dropwise over 2 h at 80° C. to 500 g Desmodur 44 M. The reaction temperature was left at a maximum of 120° C., taking its exothermic character into consideration, until the free NCO content was less than 0.5%. The calculated, blocked NCO content was 10.9%.

In the following examples of coating copper wires a horizontal wire enamelling line obtained from Aumann, Espelkamp, FRG, model FLK 240 with an oven length of 2.4 m (slightly modified for medium-thick wire diameters) was used. The copper wire of diameter 0.5 mm was enamelled by spray application in 7 stages at an oven temperature of 450° C./500° C. at a rate of 14-16 m/min.

A hydroxy-functional polyurethane (OH value=105) produced from 100 g 4,4′-diisocyanatodiphenylmethane, 14.1 g diethylene glycol, 12.0 g 1,3-butane diol and 35.7 g trimethylol propane and dissolved in MPA was used as OH component B).

### Example 8

Production of an Electrical Insulating Coating According to the Invention

515 g of the hydroxyurethane B) dissolved in MPA were added to 412 g of the polyisocyanate coating resin A) produced according to Example 2 and diluted with 605 g cresol. A wire coated with this enamel could be soldered at 390° C. within 8 sec, the tan δ breakpoint was 177° C., the softening temperature according to IEC 851, Part 6, 4.1.2 was 300° C. The enamel film displayed high flexibility: after 20% pre-extension the wire could be wound around a 0.5 mm cylindrical core without the enamel film exhibiting any cracks. The heat shock with 5% pre-extension on a 0.5 mm core after 30 min at 200° C. was acceptable.

### Example 9

Production of an Electrical Insulating Coating According to the Invention

515 g of the hydroxyurethane B) dissolved in MPA were added to 405 g of the polyisocyanate coating resin A) produced according to Example 3 and diluted with 578 g MPA.

A wire coated with this enamel could be soldered at 390° C. within 6 sec, the tan δ breakpoint was 162° C., the softening temperature according to IEC 851, Part 6, 4.1.2 was 300° C. The enamel film displayed high flexibility: after 20% pre-extension the wire could be wound around a 0.5 mm cylindrical core without the enamel film exhibiting any cracks. The heat shock with 10% pre-extension on a 0.5 mm core after 30 min at 200° C. was acceptable.

### Example 10

Production of an Electrical Insulating Coating According to the Invention

515 g of the hydroxyurethane B) dissolved in MPA were added to 326 g of the polyisocyanate coating resin A) produced according to Example 4 and diluted with 625 g MPA.

A wire coated with this enamel could be soldered at 390° C. within 5 sec, the tan δ breakpoint was 175° C., the softening temperature according to IEC 851, Part 6, 4.1.2 was 300° C. The enamel film displayed high flexibility: after 20% pre-extension the wire could be wound around a 0.5 mm cylindrical core without the enamel film exhibiting any cracks. The heat shock with 10% pre-extension on a 0.5 mm core after 30 min at 200° C. was acceptable.

### Example 11

Production of an Electrical Insulating Coating According to the Invention

515 g of the hydroxyurethane B) dissolved in MPA were added to 372 g of the polyisocyanate coating resin A) produced according to Example 5 and diluted with 565 g MPA.

A wire coated with this enamel could be soldered at 390° C. within 4 sec, the tan δ breakpoint was 172° C., the softening temperature according to IEC 851, Part 6, 4.1.2 was 300° C. The enamel film displayed high flexibility: after 20% pre-extension the wire can be wound around a 0.5 mm cylindrical core without the enamel film exhibiting any cracks. The heat shock with 5% pre-extension on a 0.5 mm core after 30 min at 200° C. was acceptable.

### Example 12

Production of an Electrical Insulating Coating According to the Invention

515 g of the hydroxyurethane B) dissolved in MPA were added to 385 g of the polyisocyanate coating resin A) produced according to example 6 and diluted with 578 g MPA.

A wire coated with this enamel could be soldered at 390° C. within 6 sec, the tan δ breakpoint was 165° C., the softening temperature according to IEC 851, Part 6, 4.1.2 was 290° C. The enamel film displayed high flexibility: after 20% pre-extension the wire could be wound around a 0.5 mm cylindrical core without the enamel film exhibiting any cracks. The heat shock with 10% pre-extension on a 0.5 mm core after 30 min at 200° C. was acceptable.

### Example 13

Production of an Electrical Insulating Coating According to the Invention

515 g of the hydroxyurethane B) dissolved in MPA were added to 386 g of the polyisocyanate coating resin A) produced according to Example 7 and diluted with 579 g MPA.

A wire coated with this enamel could be soldered at 390° C. within 4 sec, the tan δ breakpoint was 165° C., the softening temperature according to IEC 851, Part 6, 4.1.2 was 300° C. The enamel film displayed high flexibility: after 20% pre-extension the wire could be wound around a 0.5 mm cylindrical core without the enamel film exhibiting any cracks. The heat shock with 10% pre-extension on a 0.5 mm core after 30 min at 200° C. was acceptable.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A binder comprising:
A) at least one blocked polyisocyanate having urea and/or hydantoin groups, prepared from
a) 40 to 60 wt. % of an organic polyisocyanate or a blend of organic polyisocyanates,
b) 5 to 25 wt. % of at least one aspartic acid ester,
c) optionally 0.1 to 10 wt. % of a polyhydroxy compound with a molecular weight between 62 and 3000 g/mol, and
d) 25 to 45 wt. % of a blocking agent for NCO groups, whereby the ratio of unreacted isocyanate groups to blocking agents is 1:0.8 to 1:2
B) at least one hydroxyl component having an ester, imide, amide and/or urethane group, and
C) at least one organic solvent,
D) optionally auxiliary substances and/or additives.

2. The binder of claim 1 wherein a) comprises aromatically bonded isocyanate groups having an average statistical NCO functionality of 2 to 2.2 and an, optionally average statistical, molecular weight of 174 to 300.

3. The binder of claim 1 and 2 wherein the aspartic acid ester b) comprises difunctional and trifunctional amine groups in a ratio of 1:2 to 5:1.

4. The binder of claim 1 to 3 wherein component B) comprises a hydroxy-functional polyurethane.

5. A process for the production of a binder comprising the step of mixing the blocked polyisocyanate coating resins A) with hydroxyl components B), organic solvents C) and optionally auxiliary substances and additives D) at room temperature, wherein the equivalence ratio of blocked isocyanate groups of component A) to hydroxyl groups of component B) is 1:1.5 to 2:1.

6. The process of claim 5 wherein the equivalence ratio of blocked isocyanate groups of component A) to hydroxyl groups of component B) is 1:1.3 to 1.5:1

7. A substrate coated with a coating composition comprising the binder of claim 1.

8. A metal coated with a coating composition comprising the binder of claim 1.
